(19) United States
(12) Patent Application Publication
(10) Pub. No.: US 2025/0344144 A1
(43) Pub. Date: Nov. 6, 2025

(54) EFFICIENT DATA TRANSMISSION IN STORE AND FORWARD SYSTEM

(71) Applicant: Nokia Technologies Oy, Espoo (FI)

(72) Inventors: Xiang XU, Beijing (CN); Jeroen WIGARD, Aalborg (DK); Mads LAURIDSEN, Aalborg (DK); Jedrzej STANCZAK, Wroclaw (PL); Srinivasan SELVAGANAPATHY, Bangalore (IN); Daniela LASELVA, Aalborg (DK)

(21) Appl. No.: 18/870,970

(22) PCT Filed: Jun. 10, 2022
(86) PCT No.: PCT/CN2022/098248

§ 371 Date: Dec. 2, 2024

(51) Int. Cl. H04W 48/20; H04W 68/06

(52) U.S. Cl. CPC H04W 48/20; H04W 68/06

(57) ABSTRACT

Embodiments of the present disclosure relate to methods, devices and computer readable media for communication. In a method, a core network device determines a plurality of access network devices for transmitting first data to a terminal device. Each of the access network devices moves relative to the core network device. In response to a first access network device connecting to the core network device, the core network device transmits first information to the first access network device. The first information comprises the first data and first identification information of the first data. In response to a second access network device connecting to the core network device, the core network device transmits second information to the second access network device. The second information comprises at least the first data and the first identification information. In this way, the success rate of transmission is improved and the latency is reduced.

### FIELD

Embodiments of the present disclosure generally relate to the field of telecommunication, and in particular, to a core network device, an access network device, a terminal device, methods, apparatuses, and computer-readable storage media for efficient data transmission in a store and forward system.

### BACKGROUND

With development of communication technology, more and more communication scenarios may relate to a non-terrestrial network (NTN). A NTN refers to networks or segments of networks using an airborne or space-borne vehicle to embark a transmission equipment relay node or base station or using radio frequency (RF) resources on board a satellite (SAT) or unmanned aerial system (UAS) platform. The core network (CN) device may transmit data, such as downlink (DL) data, to the terminal device via an access network device on a satellite whose coverage area overlaps with the Registration Area/Tracking Area of the terminal device.

The store and forward architecture enables a low-cost deployment consisting of just a few satellites and a few CN devices. Since the access network device on the satellite is not always connected with the CN device, the CN device knows whether the data (for example, the DL data) is successfully transmitted to the terminal device only when the access network device on the satellite is reconnected to the CN device, resulting in high latency and high rate of transmission failure. Thus, enhancements on transmissions in NTN are needed, especially enhancements on DL transmissions.

### SUMMARY

In general, embodiments of the present disclosure provide methods, devices and computer storage media for efficient data transmission in a store and forward system.

In a first aspect, there is provided a core network device. The core network device comprises at least one processor and at least one memory comprising computer program code. The at least one memory and the computer program code are configured to, with the at least one processor, cause the core network device to: determine a plurality of access network devices for transmitting first data from the core network device to a terminal device, each of the plurality of access network devices moving relative to the core network device; in response to a first access network device among the plurality of access network devices connecting to the core network device, transmit first information to the first access network device, the first information comprising the first data and first identification information of the first data; and in response to a second access network device among the plurality of access network devices connecting to the core network device, transmit second information to the second access network device, the second information comprising at least the first data and the first identification information of the first data.

In a second aspect, there is provided an access network device. The access network device comprises at least one processor and at least one memory comprising computer program code. The at least one memory and the computer program code are configured to, with the at least one processor, cause the access network device to: receive, from a core network device, information comprising first data to be transmitted to a terminal device and first identification information of the first data, wherein the access network device moves relative to the core network device; transmit, to the terminal device, a paging message comprising the first identification information; and in response to the terminal device initiating a service request procedure with the access network device, transmit the first data to the terminal device.

In a third aspect, there is provided a terminal device. The terminal device comprises at least one processor and at least one memory comprising computer program code. The at least one memory and the computer program code are configured to, with the at least one processor, cause the terminal device to: receive, from an access network device, a paging message comprising first identification information of first data, wherein the access network device moves relative to the terminal device; determine, based on the first identification information, whether the first data is previously received by the terminal device; and in response to determining that the first data is not previously received, initiate a service request procedure with the access network device; and receive the first data from the access network device.

In a fourth aspect, there is provided a method. The method comprises: determining, at a core network device, a plurality of access network devices for transmitting first data from the core network device to a terminal device, each of the plurality of access network devices moving relative to the core network device; in response to a first access network device among the plurality of access network devices connecting to the core network device, transmitting first information to the first access network device, the first information comprising the first data and first identification information of the first data; and in response to a second access network device among the plurality of access network devices connecting to the core network device, transmitting second information to the second access network device, the second information comprising at least the first data and the first identification information of the first data.

In a fifth aspect, there is provided a method. The method comprises: receiving, at an access network device and from a core network device, information comprising first data to be transmitted to a terminal device and first identification information of the first data, wherein the access network device moves relative to the core network device; transmitting, to the terminal device, a paging message comprising the first identification information; and in response to the terminal device initiating a service request procedure with the access network device, transmitting the first data to the terminal device.

In a sixth aspect, there is provided a method. The method comprises: receiving, at a terminal device and from an access network device, a paging message comprising first identification information of first data, wherein the access network device moves relative to the terminal device; determining, based on the first identification information, whether the first data is previously received by the terminal device; and in response to determining that the first data is not previously received, initiating a service request procedure with the access network device; and receiving the first data from the access network device.

In a seventh aspect, there is provided an apparatus. The apparatus comprises: means for determining, at a core network device, a plurality of access network devices for transmitting first data from the core network device to a terminal device, each of the plurality of access network devices moving relative to the core network device; means for transmitting first information to the first access network device in response to a first access network device among the plurality of access network devices connecting to the core network device, the first information comprising the first data and first identification information of the first data; and means for transmit second information to the second access network device in response to a second access network device among the plurality of access network devices connecting to the core network device, the second information comprising at least the first data and the first identification information of the first data.

In an eighth aspect, there is provided an apparatus. The apparatus comprises: means for receiving, at an access network device and from a core network device, information comprising first data to be transmitted to a terminal device and first identification information of the first data, wherein the access network device moves relative to the core network device; means for transmitting, to the terminal device, a paging message comprising the first identification information; and means for transmitting the first data to the terminal device in response to the terminal device initiating a service request procedure with the access network device.

In a ninth aspect, there is provided an apparatus. The apparatus comprises: means for receiving, at a terminal device and from an access network device, a paging message comprising first identification information of first data, wherein the access network device moves relative to the terminal device; means for determining, based on the first identification information, whether the first data is previously received by the terminal device; means for initiating a service request procedure with the access network device in response to determining that the first data is not previously received; and means for receiving the first data from the access network device.

In a tenth aspect, there is provided a computer readable medium having instructions stored thereon. The instructions, when executed on at least one processor, cause the at least one processor to perform the method according to any of the fourth, fifth and sixth aspects of the present disclosure.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which some example embodiments of the present disclosure can be implemented;

FIG. 2 illustrates a schematic diagram illustrating example coverage areas of different access network devices for transmitting data to a terminal device according to embodiments of the present disclosure;

FIG. 3 illustrates a schematic diagram illustrating a process for communication according to embodiments of the present disclosure;

FIG. 4 illustrates a schematic diagram illustrating another process for communication according to embodiments of the present disclosure;

FIG. 5 illustrates an example implementation of a process for communication according to embodiments of the present disclosure;

FIG. 6 illustrates another example implementation of a process for communication according to embodiments of the present disclosure;

FIG. 7 illustrates an example method of communication implemented at a core network device in accordance with some example embodiments of the present disclosure;

FIG. 8 illustrates an example method of communication implemented at an access network device in accordance with some example embodiments of the present disclosure;

FIG. 9 illustrates an example method of communication implemented at a terminal device in accordance with some example embodiments of the present disclosure;

FIG. 10 illustrates a simplified block diagram of a device that is suitable for implementing some example embodiments of the present disclosure; and

FIG. 11 illustrates a block diagram of an example of a computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It should also be noted that in some alternative implementations, the functions/acts noted may occur out of the order noted in the figures. For example, two functions or acts shown in succession may in fact be executed concurrently or may sometimes be executed in the reverse order, depending upon the functionality/acts involved.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (30G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “core network (CN) device” refers to any device or entity that provides access and mobility management function (AMF), session management function (SMF), user plane function (UPF), etc. By way of example rather than limitation, the CN device may be a mobility management entity (MME), an AMF, a SMF, a UPF, etc. In other embodiments, the CN device may be any other suitable device or entity.

As used herein, the term “access network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like. Part of the access network device, or all the network device may be hosted on a satellite, a unmanned aerial systems (UAS) platform, or other airborne or space-borne platform. Hereafter, the satellite and the access network device are used equally.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (30G), the fourth generation (4G), 4.5G, the fifth generation (5G) communication protocols, 5.5G, 5G-Advanced networks, or the sixth generation (6G) networks.

As used herein, the footprint of a satellite is the whole area covered by the satellite during its travel around the Earth. The footprint is usually geographically divided into “beams” through the use of antennas (e.g., the antennas may be used to create fixed, static beams or may be used to create dynamically adjustable beams through beam-forming techniques). Each beam covers a particular geographic region within the footprint. Beams may be directed so that more than one beam from the same satellite covers the same specific geographic region. In addition, beams from multiple satellites may be directed to cover the same geographic region. The area covered by a beam transmitted from (e.g., a corresponding antenna of) the satellite is referred to herein as the beam coverage area. A satellite may receive signals from and transmit signals to a terminal device when the terminal device is within the “beam coverage area” of the satellite. Thus, the “footprint” or “coverage area” of a satellite may be defined as a collection of a number of beam coverage areas provided by a number of beams transmitted from the satellite.

Geosynchronous satellites have long been used for communication. A geosynchronous satellite is stationary relative to a given location on the Earth, and thus there is little timing shift and Doppler frequency shift in radio signal propagation between a communication transceiver on the Earth and the geosynchronous satellite. However, because geosynchronous satellites are limited to a geosynchronous orbit (GSO), which is a circle having a radius of approximately 42,164 km from the center of the Earth directly above the Earth's equator, the number of satellites that may be placed in the GSO is limited.

As alternatives to geosynchronous satellites, communication systems which utilize a constellation of satellites in non-geosynchronous orbits (NGSO), such as low-earth orbits (LEO), have been devised to provide communication coverage to the entire Earth or at least large parts of the Earth. In NGSO satellite-based systems, such as LEO satellite-based systems, the satellites move relative to ground-based communication devices such as core network devices or terminal devices.

As discussed above, the store and forward architecture enables a low-cost deployment consisting of just a few satellites and a few CN devices, but with the sacrifice of transmission efficiency and resource utilization. The satellite is not always connected with the CN device, or with the terminal device. For example, the satellite may have connection with the CN device for a period of time, then no connection with the CN device for another period of time. Similarly, the satellite coverage area may overlap the area of the terminal device and may serve the terminal device for a period of time, then no coverage overlap and not serve the terminal device for another period of time. The mobile originated or mobile terminate service request procedure requires multiple interactions between the terminal device and the satellite, and multiple interactions between the satellite. Due to the discontinuous connection between the satellite and the CN device, and between the satellite and the terminal device, the mobile originated or mobile terminate service request procedure may take a long time to complete. For example, for mobile terminate service request procedure, the CN device request the satellite to perform Paging when the satellite have connection with the CN device (i.e. the first pass-over). The CN device only knows that the paging is successful or failed when the satellite have the connection with the CN device again (i.e. the second pass-over), which may be hours or even days after the previous connection between the satellite and CN device. In case a paging failure, the CN device then initiates a second paging procedure. This results in high latency. In addition, the terminal device might have moved to another location during this period of time, thus resulting in high transmission failure.

Furthermore, the CN device only knows the location of the terminal device at the Registration Area/Tracking Area level. The area may not be completely covered by one satellite during one pass-over and the coverage area of different satellites may not be the same. For example, two satellites may provide different partial coverage of one Tracking Area. Thus, it is challenging for the CN device to determine which satellite(s) to use to attempt to page the terminal device and transmit the data.

A new solution for data transmission in the store and forward architecture in NTN with increased success rate, reduced latency and high energy efficiency is needed. In addition, when one satellite has managed to transmit the data to the terminal device, it would be beneficial to avoid subsequent data transmission attempt from other satellites.

Principle and example embodiments of the present disclosure will be described in detail below with reference to the accompanying drawings.

In the following, a satellite will be used as an example of an access network device for describing some specific example embodiments of the present disclosure. It is noted that example embodiments described with regard to the satellite are equally applicable to any other suitable types of an access network device.

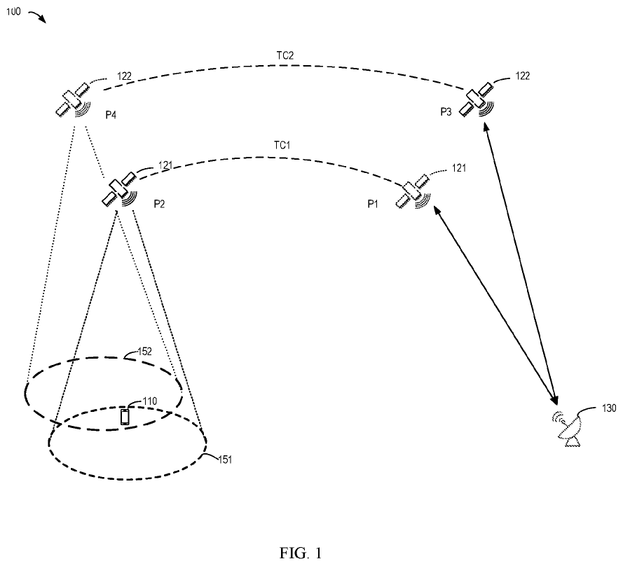

FIG. 1 shows an example communication environment 100 in which example embodiments of the present disclosure can be implemented. The network environment 100 includes a terminal device 110, first and second access network devices 121 and 122 (e.g., NGSO satellites) and a CN device 130. Although only two access network devices 121 and 122 are shown for clarity of illustration, the CN device 130 may utilize more than two access network devices to communicate with the terminal device 110.

The CN device 130 may implement any suitable functionality. For example, the CN device 130 may have access to data network, Internet or one or more other types of public, semiprivate or private networks. Communication between each of the access network devices 121 and 122 and the CN device 130 in both directions are called feeder links, whereas communication between each of the access network devices and the terminal device 110 in both directions are called service links.

As shown in FIG. 1, the first and second access network devices 121 and 122 travel in non-geosynchronous orbits TC1 and TC2, respectively. The access network devices 121 and 122 may orbit the Earth in any suitable number of non-geosynchronous orbital planes (not shown for simplicity), and each of the orbital planes may include multiple access network devices (e.g., NGSO satellites). The non-geosynchronous orbital planes may include, for example, polar orbital patterns and/or Walker orbital patterns. Thus, to a stationary observer on Earth, the access network devices 121 and 122 appear to move quickly across the sky in multiple different paths across the Earth's surface, with each of the access network devices 121 and 122 providing coverage for a corresponding path across the Earth's surface.

As discussed above, the CN device 130 may only know the location of the terminal device 110 at the Registration Area/Tracking Area level. The area may only be partially covered by the footprint of the first access network device 121 or the footprint of the second access network device 122. As shown in FIG. 1 when in position P2 in orbit TC1, the first access network device 121 provides a beam coverage area 151. When in position P4 in orbit TC2, the second access network device 122 provides a beam coverage area 152. For example, when the CN device 130 decides to transmit data to the terminal device 110 via the first access device 121, there is a possibility that the terminal device 110 locates at a portion of the Tracking Area not covered by the footprint of the first access network device 121.

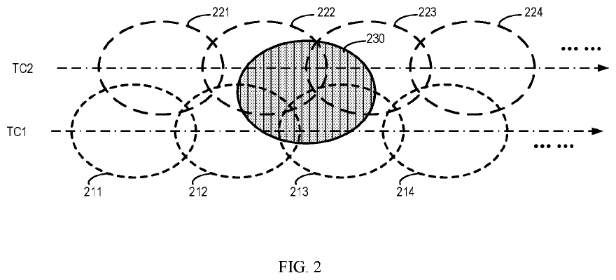

FIG. 2 illustrates a schematic diagram illustrating example coverage areas of different access network devices 121 and 122 for transmitting data to the terminal device 110 in a tracking area 230 according to embodiments of the present disclosure.

For the example diagram of FIG. 2, the beam coverage areas 211, 212, 213, 214, and so on provided by respective beams transmitted from the first access device 121 in the orbit TC1 may define the footprint (or coverage area) of first access device 121. Each of the beam coverage areas 211, 212, 213, 214, . . . may extend across an entire width of the satellite's footprint. Adjacent pairs of the beam coverage areas 211, 212, 213, 214, . . . may touch and/or overlap each other, for example, so that the footprint provided by the beams may have minimal coverage gaps. In the example of FIG. 2, the beam coverage areas 212 and 213 partially overlap with the Tracking Area 230 of the terminal device 110. The first access device 121 may communicate with the terminal device 110 if the terminal device locates in the footprint of the first access device 121. Similarly, the beam coverage areas 221, 222, 223, 224, . . . provided by respective beams transmitted from the second access device 122 in the orbit TC2 may define the footprint (or coverage area) of second access device 122. In the example of FIG. 2, the beam coverage areas 222 and 223 partially overlap with the Tracking Area 230 of the terminal device 110. For clarity of illustration, the orbits TC1 and TC2 of the first and second access devices 121 and 122 are shown to be in parallel and each of the beam coverage areas 211, 212, 213, 214, . . . and beam coverage areas 221, 222, 223, 224, . . . are shown with the same shape and the same size, however, the present disclosure is not limited in these regards.

Return to FIG. 1, in the example of FIG. 1, when in position P1 in orbit TC1, the first access network device 121 may connect to and communicates with the CN device 130. When the first access network device 121 travels in the orbit TC1 and arrives at the position P2, the first access network device 121 does not have connection with the CN device 130, and the first access network device 121 provides a beam coverage area 151. In case that the terminal device 110 is within the beam coverage area 151 of the first access network device 121, the terminal device 110 may communicate with the first access network device 121 via such as a service link or radio link. Similarly, when the second access network device 122 is in position P3 in orbit TC2, the second access network device 122 may connect to and communicates with the CN device 130. When the second access network device 122 travels in the orbit TC2 and arrives at the position P4, the second access network device 122 does not have connection with the CN device 130, and the second access network device 122 provides a beam coverage area 152. In case that the terminal device 110 is within the beam coverage area 152 of the second access network device 122, the terminal device 110 may communicate with the second access network device 122 via such as a service link or radio link. Communication in a direction from a terminal device towards the access network device is referred to as uplink communication, while communication in a reverse direction from the access network device towards the terminal device is referred to as downlink communication.

In addition, in the example of FIG. 1, the terminal device 110 may or may not move over time. When moving, the terminal device 110 may be located in different areas and also may be out of the coverage of the network (e.g., out of the footprint of the first access network device 121 and/or the second access network device 122) sometimes.

In the example of FIG. 1, the terminal device 110 may be in different Radio Resource Control (RRC) states (such as, connected state, inactive state and idle state) and also may operate on a power saving mechanism including but not limited to DRX, eDRX, PSM, relaxed monitoring and so on.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their connections of access network devices, terminal devices and CN devices are only for the purpose of illustration without suggesting any limitations. The communication environment 100 may include any suitable access network devices, terminal devices, and CN devices adapted for implementing embodiments of the present disclosure. Although not shown, it is to be understood that one or more additional network devices may comprised in communication environment 100, such as, a terrestrial station, a gateway and so on.

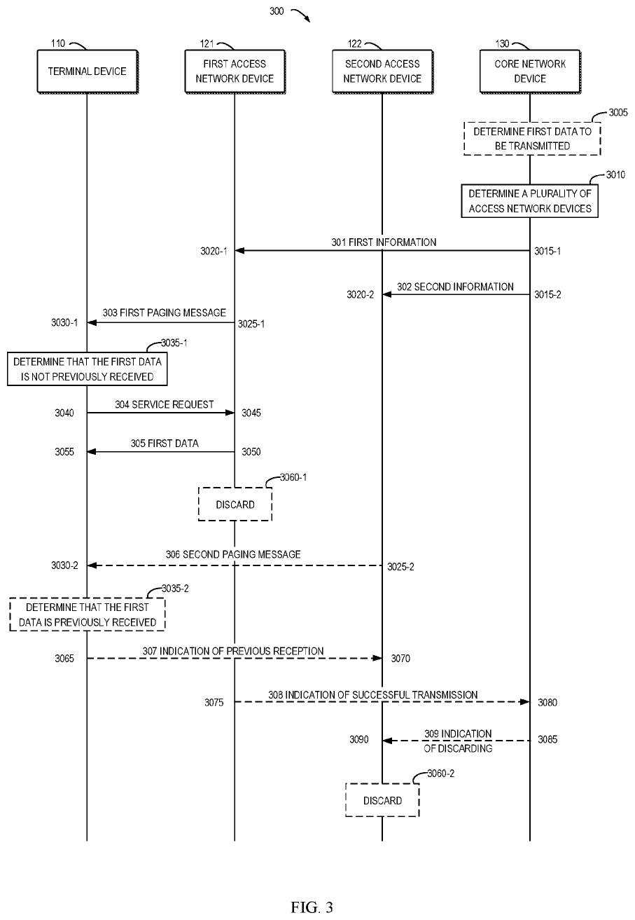

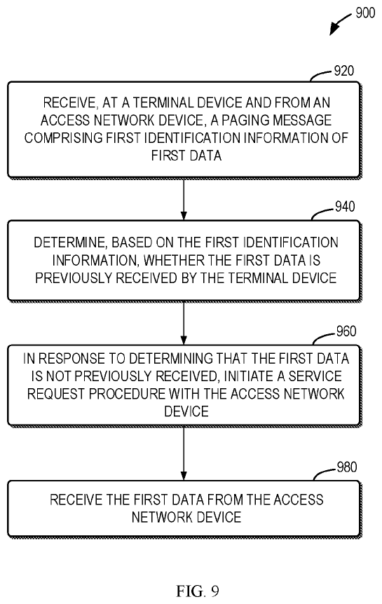

In this embodiment, a solution is provided to transmit the DL data to the terminal device at the earliest possibility and in an energy efficient way (e.g. not requiring the terminal device to receive the duplicated data). This will be described in connection with FIGS. 3 and 9.

FIG. 3 illustrates a schematic diagram illustrating a process 300 for communication according to embodiments of the present disclosure. For the purpose of discussion, the process 300 will be described with reference to FIG. 1. The process 300 may involve the terminal device 110, the first and second access network devices 121 and 122 and the core network device 130 as illustrated in FIG. 1. The first and second access network devices 121 and 122 move relative to the terminal device 110 and the core network device 130.

As shown in FIG. 3, the core network device 130 determines (3010) multiple access network devices for transmitting a first data 305 from the core network device 130 to the terminal device 110. Each of the access network devices moves relative to the core network device. In other words, the connection between the core network device 130 and each of the access network devices is temporary and discontinuous. There may be various manners for the core network device 130 to determine which access network devices to be used to transmit the first data 305. In some example embodiments, the core network device 130 may determine the multiple access network devices for transmitting the first data 305 to the terminal device 110 based on the location of the terminal device 110 (based on either Global Navigation Satellite System (GNSS) or last known location of the terminal device 110 (for example, the last serving cell, the last tracking area, etc.), satellite constellation and the location of the NTN gateway (NTN-GW) which is an earth station located at the surface of the earth, providing connectivity to the access network device using the feeder link. In some example embodiments, the core network device 130 may determine the multiple access network devices based on the configuration, or based on the traffic type. The core network device 130 may determine the multiple access network devices based on how urgent the transmission of the first data 305 is. For example, the core network device 130 may determine that the first data 305 needs to be delivered as early as possible by assessing its quality of service (QoS) related priorities. Alternatively or additionally, the core network device 130 may determine the multiple access network devices based on the time required for the access network device to move to a position where it can connect to the core network device and/or the time required for the access network device to move to a position where it can connect to the terminal device after the access network device has connected with the core network device.

Without loss of generality, it is assumed that the multiple access network devices determined by the core network device 130 may include the first access network device 121 and the second access network device 122. The first and second access network devices 121 and 122 may connect with the core network device 130 at the same or different time periods. Upon the first access network device 121 connecting to the core network device 130, the core network device 130 transmits (3015-1) first information 301 to the first access network device 121. Upon the second access network device 122 connecting to the core network device 130, the core network device 130 transmits (3015-2) second information 302 to the second access network device 122. Both the first information 301 and the second information 302 comprise the first data 305 and the first identification information of the first data 305. Although the transmission 3015-1 to the first access network device 121 is shown to be performed before the transmission 3015-2 to the second access network device 122, the transmission 3015-1 to the first access network device 121 may be also performed at the same time as or after the transmission 3015-2 to the second access network device 122.

The first access network device 121 receives (3020-1) the first information 301 from the core network device 130. The first access network device 121 transmits (3025-1) a first paging message 303, comprising the first identification information, to the terminal device 110. The terminal device 110 receives (3030-1) the first paging message 303 from the first access network device 121. In some example embodiments, the first access network device 121 transmits the first paging message 303 when the first access network device 121 travels to a position at which its beam coverage area begins to overlap with the tracking area of the terminal device 110. If the terminal device 110 locates at the overlapping area, the terminal device 110 would receive the first paging message 303 from the first access network device 121. The terminal device 110 determines, based on the first identification information, whether the first data 305 is previously received by the terminal device 110.

Upon determining (3035-1) that the first data 305 is not previously received, the terminal device 110 initiates a service request procedure with the first access network device 121. As used herein, the service request procedure may be early data transmission (EDT) or ordinary Radio Resource Control (RRC) connection setup. The situation that the terminal device 110 has not received the first data may be because the first access network device 121 is the first access network device connected to the UE among the multiple access network devices, or may be due to transmission failure from the network device(s) previously connected to the terminal device 110 due to, for example, poor channel quality, etc. For example, if the first access network device 121 connects to the terminal device 110 earlier than the second access network device 122 (and other access network devices among the multiple access network devices), or if the terminal device 110 is located in the footprint of the first access network device 121 but not in the footprint of the second access network device 122 (and other access network devices among the multiple access network devices), the terminal device 110 may have not received the first data when the terminal device 110 is connect to the first access network device 121. The terminal device 110 transmits (3040) a service request 304 to the first access network device 121. The first access network device 121 receives (3045) the service request from the terminal device 110 and transmits (3050) the first data 305 to the terminal device 110. The terminal device 110 receives (3055) the first data 305 from the first access network device 121. In this way, the core network may utilize multiple access network devices to attempt to transmit data to the terminal device. The success rate of data transmission is increased and the latency is reduced. Furthermore, by including identification information of the DL data in the paging message, duplicated transmission of the same data is avoided, thus enabling low resource consumption.

In some example embodiments, before determining (3010) the multiple access network devices, the core network device 130 may determine (3005) first data to be transmitted to the terminal device 110. Alternatively, the core network device 130 may receive the first data 305 to be transmitted to the terminal device 110 from the data network.

In some example embodiments, a coverage area of each of the access network devices may at least partially overlap at least one of a tracking area, a registration area, and a potential area associated with the terminal device during a period of time, e.g., a period between the consecutive connections between the corresponding access network device and the core network device 130, a preconfigured time (for example, 24-hour), etc. In the example of FIG. 3, the core network device 130 may determine to deliver the first data 305 to the terminal device 110 via at least the first and second access network devices 121 and 122. The first and second access network devices 121 and 122 may be selected based on (partial) overlapping of their coverage areas with the tracking area or the registration area of the terminal device 110 or a potential area that the terminal device 110 may have moved into during a period of time, e.g., between the consecutive connections between the corresponding access network device and the core network device 130. In this way, the success rate of data transmission may be increased, thus reducing latency.

In some example embodiments, the first identification information of the first data may comprise identifier(s) associated with respective data packet(s) of the first data 305. In some example embodiments, each of the identifier(s) may comprise a timestamp when the core network device 130 received the associated data packet. Alternatively or additionally, each of the identifier(s) may comprise a sequence number of the associated data packet. Alternatively or additionally, the each of the identifier(s) may comprise any suitable identifier that is unique to the associated data packet. The first identification information of the first data may be only unique for the specific terminal device 110. In this way, the terminal device is able to determine whether it has already received the first data based on the identifier of the data packet. Duplicated transmission of the same data may be avoided, thus reducing resource consumption.

In some example embodiments, the first data 305 may comprise multiple data packets. The first identification information may comprise at least one of: the number of data packets of the first data 305, an identifier associated with a first data packet of the first data 305, an identifier associated with a last data packet of the first data 305, and an identifier associated with every data packet of the first data 305. In some example embodiments, the identifier associated with the first data packet may comprise a timestamp when the core network device 130 received the first data packet and/or a sequence number of the first data packet. The identifier associated with the last data packet may comprise a timestamp when the core network device 130 received the last data packet and/or a sequence number of the last data packet. For example, the first data may be identified with first identification information comprising a sequence number of the first data packet and the number of data packets in the first data. In this way, the data may be identified in a simplified manner, which also facilitates the terminal device to determine whether it has already received the first data.

In some example embodiments, the first access network device 121 may discard (3060-1) the first data 305 after transmitting the first data 305 to the terminal device 110. In some other example embodiment, the first data 305 may comprise multiple data packets and only some data packets are successfully transmitted to the terminal device 110, the first access network device 121 may only discard (3060-1) those data packets that have been successfully transmitted to the terminal device 110. In this way, the storage space of the storage device in the access network device may be saved, thereby improving the operation efficiency of the access network device.

In some example embodiments, the second access network device 122 receives (3020-2) the second information 302 from the core network device 130. The second access network device 122 transmits (3025-2) a second paging message 306, comprising the first identification information, to the terminal device 110. The terminal device 110 receives (3030-2) the second paging message 306 from the second access network device 122. In some example embodiments, the second access network device 122 transmits the second paging message 306 when the second access network device 122 travels to a position at which its beam coverage area begins to overlap with the tracking area of the terminal device 110. If the terminal device 110 locates at the overlapping area, the terminal device 110 would receive the second paging message 306 from the second access network device 122. The terminal device 110 determines, based on the first identification information, whether the first data 305 is previously received by the terminal device 110.

In some example embodiments, upon determining (3035-2) that the first data 305 is previously received, the terminal device 110 transmits (3065), to the second access network device 122, an indication 307 that the first data 305 is previously received by the terminal device 110. Alternatively or additionally, upon determining that the first data 305 is previously received, the terminal device 110 skips the initiation of the service request procedure with the second access network device 122. In some other example embodiment, the first data 305 may comprise multiple data packets. The terminal device 110 may determine that only some data packets are previously received by the terminal device 110, the terminal device 110 may continue the paging response and inform the second access network device 122 to skip those already received data packets and only transmit the data packets that have not been received by the terminal device 110. In this way, duplicated transmission of the same data may be avoided and power consumption may be reduced.

In some example embodiments, upon reconnecting to the core network device 130, the first access network device 121 may transmit (3075), to the core network device 130, an indication 308 that the first data 305 is transmitted to the terminal device 110 successfully. In some other example embodiment, the first data 305 may comprise multiple data packets, and only some of data packets have been successfully transmitted from the first access network device 121 to the terminal device 110. The indication 308 may include the information for those successfully transmitted data packets or information for those not transmitted data packets. The core network device 130 may receive (3080) the indication 308 from the first access network device 121. Upon the second access network device 122 reconnecting to the core network device 130, the core network device 130 may transmit (3085) an indication 309 of discarding the first data 305 to the second access network device 122. In some other example embodiment, the first data 305 may comprise multiple data packets, and only some of data packets have been successfully transmitted from the first access network device 121 to the terminal device 110. The indication 309 may include the information for those successfully transmitted data packets or not transmitted data packets, so the second access network device 122 only discard those data packets that have been successfully transmitted to the terminal device 110, and keep other data packets that have not been transmitted to the terminal device 110 that may be transmitted to the terminal device 110 later. In some example embodiments, the second access network device 122 may discard (3060-2) the first data 305 or part of the first data 305 (i.e. some data packets of the first data 305) upon receiving the indication 309 of discarding the first data 305 or part of the first data 305 from the core network device 130. In this way, other access network devices may discard the data although they haven't performed the transmission such that they don't need to carry the data until a next revisit of the cell area.

In some example embodiments, the second access network device 122 may discard the first data 305 (or part of the first data 305) upon receiving the indication 307 that the first data 305 (or part of the first data 305) is previously received by the terminal device 110. In some example embodiments, the indication 307 may comprise at least one of an identifier associated with a last data packet of the first data 305, or an identifier associated with the successfully transmitted data packet of the first data 305, or an identifier associated with the unsuccessfully transmitted data packet of the first data 305. In this way, the access network device may discard the buffered data (or data packets) timely although it hasn't performed the transmission. In this way, the operation efficiency of the access network device is improved and resource overhead is reduced.

In some example embodiments, the first access network 121 may be caused to discard the first data upon a first condition for discarding the first data being reached. The first condition may be determined in various manners. For example, the first condition may be predefined. Alternatively, the first access network device 121 may be informed of the first condition by the core network device 130. The first information 301 may further comprise a first condition for the first access network device 121 to discard the first data 305. In addition, the first condition may be in various forms. For example, the first condition may comprise at least one of: an area or a location being arrived by the first access network device 121, an area or a location being passed by the first access network device 121, a time point being reached, and a period of time having elapsed since the first access network device 121 receives the first information 301. For example, the first access network device 121 receives the first information 301 from the core network device 130 at 6:00:00 GMT on Jun. 1, 2022, and is expected to arrive at the tracking area of the terminal device 110 at 11:00:00 GMT on Jun. 1, 2022 and to leave the tracking area of the terminal device 110 at 13:00:00 GMT on Jun. 1, 2022. The first access network device 121 may discard the first data 305 at 14:00:00 GMT on Jun. 1, 2022. Alternatively, the first access network device 121 may discard the first data 305 at the instant when 8 hours have elapsed since the first access network device 121 receives the first information 301. For example, the core network device 130 may determines that the last known cell of the terminal device 110 is in Shanghai. The first access network device 121 may discard the first data 305 when the first access network device 121 arrives at or passes Hangzhou along its orbit after passing Shanghai. Similarly, the second information 302 may further comprise a second condition for the second access network device 122 to discard the first data 305. In some example embodiments, the second condition may comprise at least one of: an area or a location being arrived by the second access network device 122, an area or a location being passed by the second access network device 122, a time point being reached, and a period of time having elapsed since the second access network device 122 receives the second information 302. Accordingly, the access network device 122 may discard the buffered data timely before reconnecting to the core network device and thus needn't wait for the discarding instructions from the core network device. In addition the access network device may discard the buffered data timely even if the access network device is not connected with the terminal device, for example since the terminal device is not located in the coverage area of the terminal device. In this way, the operation efficiency of the access network device may be improved and resource overhead may be reduced.

In some example embodiments, the first condition for the first access network device 121 to discard the first data 305 may be comprised in the first information 301. In other words, the core network device 130 may transmit the first data as well as the first condition to the first access network device 121. Similarly, the second condition for the second access network device 122 to discard the first data 305 may be comprised in the second information 302. In other words, the core network device 130 may transmit the first data as well as the second condition to the second access network device 122. In this way, the access network device would be aware of when it should discard the data.

In some example embodiments, the first information 301 and the second information 302 may further comprise information of the multiple access network devices for transmitting the first data 305 from the core network device 130 to the terminal device 110. For example, the information of the multiple access network devices may comprises identification information of the multiple access network devices or the identification information of the satellites which host the access network devices. In some example embodiments, the first paging message 303 may comprise the information of the multiple access network devices. In some example embodiments, the terminal device 110 may determine whether the first data 305 is previously received by the terminal device 110 based on the identification information of the data and the information of the multiple access network devices. In this way, the terminal device may is able to determine whether it has already received the first data in a more reliable and efficient manner.

In some example embodiments, the information of the multiple access network devices may be transmitted from the first access network device 121 to the terminal device 110 together with the transmission of the first data 305.

In some example embodiments, based on the information of the multiple access network devices, the terminal device 110 may determine that a second access network device 122 is among the multiple access network devices and is to transmit the first data 305 to the terminal device 110. Upon receiving a second paging message 306 from the second access network device 122, the terminal device 110 may determine whether the second paging message 306 comprises second identification information of second data in addition to the first identification information of the first data 305. For example, based on the information of the multiple access network devices received from the first access network device 121, the terminal device 110 is aware that the second access network device 122 will attempt to transmit at least the first data 305 to the terminal device 110. When receiving a paging message from the second access network device 122, the terminal device 110 already knows that the paging message comprises the first identification information of the first data 305. The terminal device 110 only needs to determine whether the paging message comprises other identification information different from the first identification information to determine whether the second access network device 122 carries additional DL data in addition to the first data 305. In this way, the terminal device is able to determine whether a service request procedure should be initiated in a more efficient manner.

In some example embodiments, upon determining that the second paging message 306 comprises the second identification information, the terminal device 110 may initiate a second service request procedure with the second access network device 122 and receive the second data from the second access network device 122. In some example embodiments, The terminal device 110 may transmit a second message to the second access network device 122 during the second service request procedure, indicating that the first data 305 is previously received by the terminal device 110. Upon receiving the second message, the second access network device 122 may transmit only the second data to the terminal device 110. In this way, duplicated transmission of the same data may be avoided and if new data exists, it can be determined in a reliable and efficient manner that new data needs to be transmitted, thus improving communication efficiency.

In some example embodiments, upon determining that the second paging message does not comprise other identification information different from the first identification information, the terminal device 110 may transmit, to the second access network device 122, an indication that the first data is previously received by the terminal device 110, or skip an initiation of a service request procedure with the second access network device 122. In this way, if no new data exists, it can be determined in a reliable and efficient manner that no new data needs to be transmitted, thus reducing operation efficiency.

In some example embodiments, based on a predefined purpose of the first data 305, the terminal device 110 may determine that the core network device 130 is not to transmit a second data to the terminal device before the terminal device 110 transmits response data for the first data 305 to the core network device, or before a timer is expired (for example, no second data in a 24-hour period). Based on the information of the multiple access network devices, the terminal device 110 may determine that a second access network device 122 is among the multiple access network devices and is to transmit the first data 305 to the terminal device 110. Upon receiving a second paging message from the second access network device 122, the terminal device 110 may skip an initiation of a second service request procedure with the second access network device. For example, in some scenarios, the core network device 130 may transmit the first data 305 to the terminal device 110 to request a response data from the terminal device 110. In some example embodiments, the core network device 130 may transmit the first data 305 via multiple access network devices. The core network device 130 would not transmit a second data to the terminal device 110 before the terminal device 110 transmits the response data for the first data 305 to the core network device 130. After receiving the first data 305 and the information of the multiple access network devices from the first access network device 121, the terminal device 110 is aware that a second access network device 122 is to transmit the same first data 305 to the terminal device 110 without additional data. Alternatively, based on the first data 305 and the information of the multiple access network devices received from the first access network device 121, the terminal device 110 determines not to receive data from the multiple access network devices before transmitting the response data to the core network device 130. Upon receiving a second paging message from the second access network device 122, the terminal device 110 may skip an initiation of a second service request procedure with the second access network device 122. In this way, after the terminal device receives the request for response data and the information of the multiple access network devices, it knows which access network devices are to send the same request to it, so it can directly skip the data transmission from these access network devices before sending the response data, thereby reducing energy consumption.

Alternatively or additionally, based on the information of the multiple access network devices received from the first access network device 121, the terminal device 110 is aware that the second access network device 122 will attempt to transmit data to the terminal device 110 and monitor paging message from the second access network device 122 based on information of the second access network device 122. For example, based on the information of the multiple access network devices, the terminal device 110 may determine an arrival time when a beam coverage area of the second access network device 122 at least partially overlaps at least one of a tracking area, a registration area, and a potential area associated with the terminal device. The terminal device 110 may detect a second paging message from second access network device 122 at the arrival time. In some example embodiments, the terminal device 110 may point its antenna at the second access network device 122 that will be providing coverage for the terminal device 110 the arrival time. This enables the terminal device 110 to reliably receive paging message transmitted by the second access network device 122. Alternatively, according to actual need, the second access network device 122 may even be turned off during the period between the connection with the access network devices 121 and 122. In this way, energy consumption may be reduced while the success rate of connection may be increased.

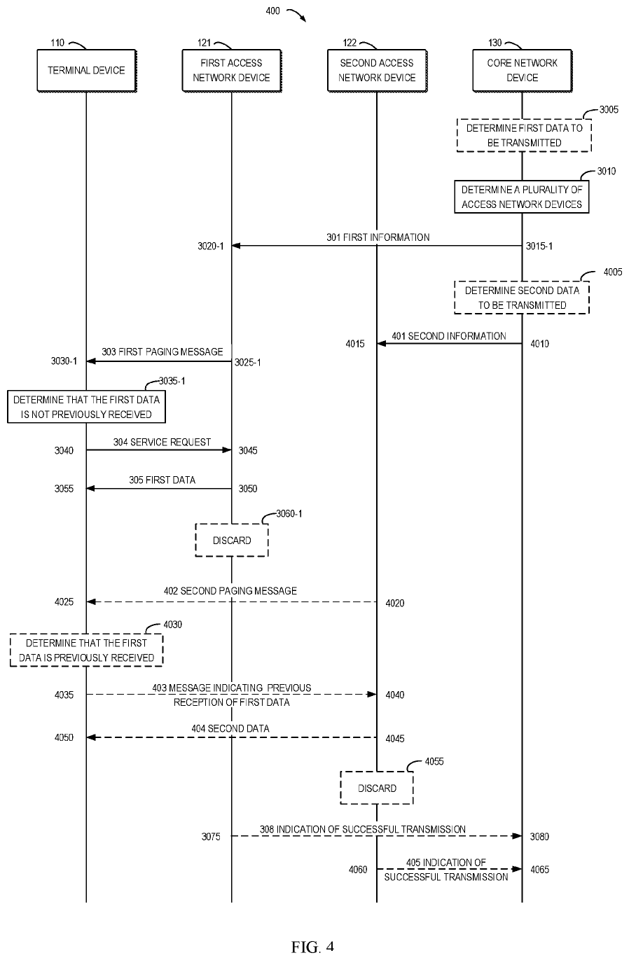

FIG. 4 illustrates a schematic diagram illustrating another process 400 for communication according to embodiments of the present disclosure. For the purpose of discussion, the process 400 will be described with reference to FIG. 1. The process 400 may involve the terminal device 110, the first and second access network devices 121 and 122 and the core network device 130 as illustrated in FIG. 1. The same reference numerals are used to denote the steps or components described in FIG. 4 having the same operations as the steps or components described in FIG. 3, and detailed description thereof will be omitted.

In the example of FIG. 4, the core network device 130 may determine to deliver the first data 305 to the terminal device 110 via at least the first and second access network devices 121 and 122. After transmitting (3015-1) the first information 301 to the first access network device 121, the core network device 130 may determine (4005) second data to be transmitted to the terminal device 110. The core network device 130 may generate second information 401. The second information 401 may comprise the first data 305, the second data 404, the first identification information of the first data 305 and the second identification information of the second data 404.

In some example embodiments, the second access network device 122 transmits (4020) a second paging message 402 to the terminal device 110. The second paging message 402 comprises the first identification information of the first data 305 and the second identification information of the second data 404. Upon determining (4030) that the first data 305 is previously received, the terminal device 110 transmits (4035) a message 403 to the second access network device 122. The message 403 indicates that the first data 305 is previously received by the terminal device 110. Upon receiving (4040) the message 403 from the terminal device 110, the second access network device 122 transmits (4045) the second data 404 to the terminal device 110 without transmitting the first data 305 to the terminal device 110. The terminal device 110 may receive (4050) the second data 404 from the second access network device 122. In this way, it can both avoid duplicated transmission of the same data and ensure the successful transmission of new data utilizing the group of access network devices, thereby reducing energy consumption and reducing latency.

In some example embodiments, the second access network device 122 may discard (4055) the first data 305 and the second data 404 after transmitting the second data 404 to the terminal device 110. Alternatively, the second access network device 122 may discard (4055) the first data 305 upon receiving the message 403 from the terminal device 110. In this way, the storage space of the storage device in the access network device may be saved, thereby improving the operation efficiency of the access network device.

In some example embodiments, upon reconnecting to the core network device 130, the second access network device 122 may transmit (4060), to the core network device 130, an indication 405 that the second data 404 is transmitted to the terminal device 110 successfully. The core network device 130 may receive (4065) the indication 405 from the second access network device 122. In this way, the core network device may receive the response of data transmission with short latency.

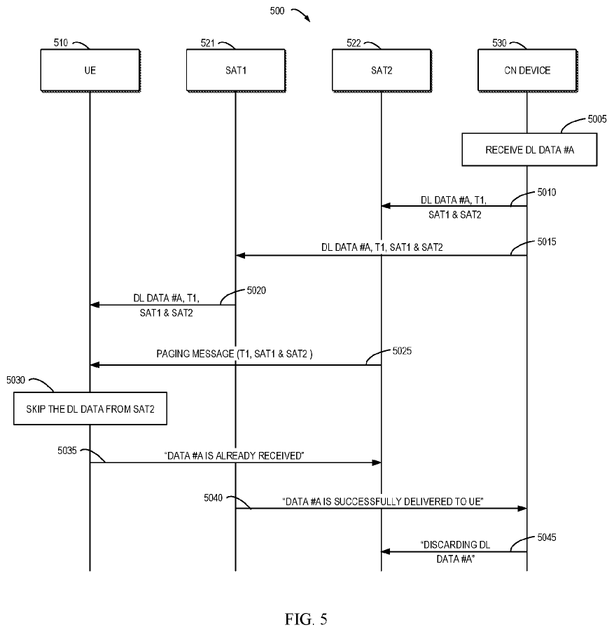

FIG. 5 illustrates an example implementation of a process 500 for communication according to embodiments of the present disclosure. It is noted that the process 500 can be considered as a more specific example of the process 300 of FIG. 3 applied into an NTN network. The example implementation of FIG. 5 is depicted and will be described from perspectives of a UE 510, a satellite (SAT1) 521, a satellite (SAT2) 522, and a CN device 530. More particularly, the SAT1 521 and the SAT2 522 moves relative to the CN device 530. Each of the SAT1 521 and the SAT2 522 may communicate with the CN device 530 when it is connected to the CN device 530. The connection between the CN device 530 and each of the SAT1 521 and the SAT2 522 is temporary and discontinuous. Each of the SAT1 521 and the SAT2 522 may communicate with the UE 510 when its coverage overlap the location of the UE 510. The connection between the UE 510 and each of the SAT1 521 and the SAT2 522 is temporary and discontinuous. The CN device 530 communicates with the UE 510 via the SAT1 521 or the SAT2 522.

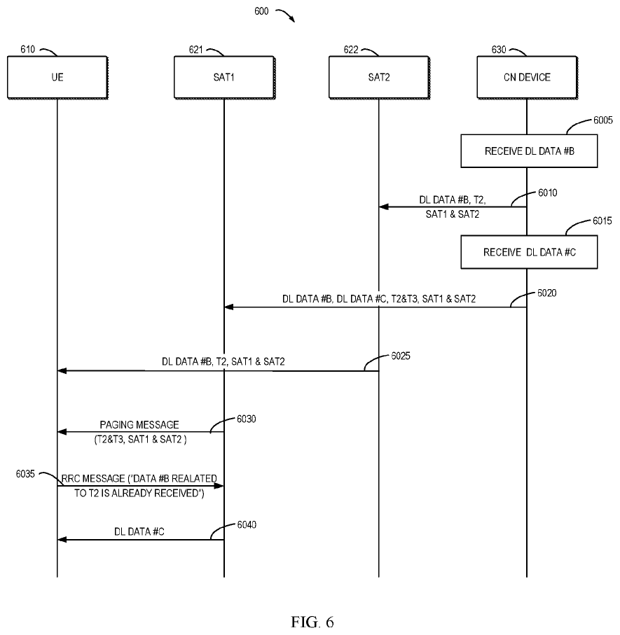

It should be understood that the satellite in the present disclosure (e.g., the SAT1 521 and the SAT2 522 in FIG. 5 and the SAT1 621 and the SAT2 622 in FIG. 6) corresponds to an access network device (for example, an eNB or gNB, or part of the eNB, or part of the gNB). If multiple base stations are on one satellite, further (direct) identification of the access network device is required. As used herein, each satellite has at least one access network device onboard and a reference to a satellite entails a reference to the access network device onboard.

In the process flow 500, the CN device 530 may receive (5005) DL data #A to be transmitted to the UE 510 at a time point T1. The CN device 530 may decide to deliver the DL data #A via the SAT1 521 and the SAT2 522. The CN device 530 may make the decision based on the configuration, or based on the traffic type. For example, by assessing the QoS-related priorities of the DL data #A, the CN device 530 knows that the DL data #A needs to be delivered as early as possible. When deciding which satellites to use to deliver the DL data, the CN device 530 may also take into account the UE location (for example, a GNSS based location or last known cell), satellite constellation and the location of the NTN-GW which is an earth station located at the surface of the earth, providing connectivity to the access network device using the feeder link.

Next, when the SAT2 522 connects with the CN device 530, the CN device 530 transmits (5010), to the SAT2 522, information including DL data #A, the ID of the DL data #A and the ID of the access network device (for example, the ID of the satellites, i.e., SAT1 and SAT2) that will send the DL data #A. When the SAT1 521 connects with the CN device 530, the CN device 530 transmits (5015), to the SAT1 521, information including DL data #A, the ID of the DL data #A and the ID of the access network device (for example, the ID of the satellites, i.e., SAT1 and SAT2) that will send the DL data #A. The SAT1 521 and the SAT2 522 may connect with the CN device 530 at different time. Although the SAT1 522 is shown to connect with the CN device 530 before the SAT1 521, it is also possible that the SAT1 522 may connect with the CN device 530 after the SAT1 521. The ID of the DL data #A can be a timestamp (e.g. T1) when the CN device 530 received the DL data #A, or a sequence number generated for the DL data #A, or any other ID that is unique to the DL data #A. In some example embodiments, the DL data #A may comprise one or multiple data packets. Each of the multiple data packets may have an associated ID, e.g., a sequence number. The ID of the data is only unique for a specific UE.

In some example embodiments, the information transmitted from the CN device 530 to the access network device (for example, SAT1 521, SAT2 522) may further comprise a condition to discard the buffered DL data (i.e., the DL data #A). The condition to discard the buffered DL data may be a specific Tracking Area or geographical area information. For example, after the access network device (for example, SAT1 521, SAT2 522) has passed the specific Tracking Area or geographical area, the SAT can discard the buffered data. The condition to discard the buffered DL data may be a specific time. For example, after 23:00, the access network device (for example, SAT1 521, SAT2 522) can discard the buffered data. The condition to discard the buffered DL data may be a specific period. For example, after the access network device (for example, SAT1 521, SAT2 522) has buffered the data for 10 hours, the access network device (for example, SAT1 521, SAT2 522) can discard the buffered data. The condition to discard the buffered DL data may be any other condition that can be used to determine whether the access network device (for example, SAT1 521, SAT2 522) should discard the buffered DL data. When the condition is absent, the access network device (for example, SAT1 521, SAT2 522) may only discard the buffered DL data after the buffered DL data has been successfully delivered to the UE, or when the access network device (for example, SAT1 521, SAT2 522) receives an explicit “discard” indication from the CN device (for example, when the DL data has been successfully delivered to the UE via other access network device), or when the access network device (for example, SAT1 521, SAT2 522) receives, from the UE, an indication that the UE has already received the DL data.

Next, when the SAT1 521 serves the area where the UE 510 locates at, the SAT1 521 transmits (5020), the DL data #A to the UE 510. The ID of the DL data #A and the ID of the satellites (i.e., SAT1 and SAT2) that will send the DL data #A are also transmitted to the UE 510. Based on the ID of the satellites (i.e., SAT1 and SAT2), the UE 510 is informed about the SATs that will transmit the duplicated DL data #A. When the UE 510 is in an idle state, a paging procedure may be performed before the transmission of the DL data #A. In case if the DL data #A is delivered over the RRC connection after paging response, each PDCP SDU includes the ID of the DL data #A. The paging procedure is not shown in FIG. 5 for simplicity.

Next, when the SAT2 522 arrives at the area where the UE 510 locates at, the SAT2 522 transmits (5025) a paging message to the UE 510 to initiate a paging procedure. The paging message includes the ID for the DL data #A (e.g. T1) in addition to the legacy indication of UE identity. In some example embodiments, the DL data #A may comprise multiple data packets. The paging message may include the ID for the first data packet, and/or the ID for the last data packet, and/or the number of data packets. Optionally, the paging message further includes SAT information (e. g. SAT1 and SAT2).

Upon receiving the paging message from the SAT2 522, the UE 510 determines, based on the data ID (e.g. T1) in the paging message, that the paging message is for transmission of the DL data #A. In one example embodiment, the UE 510 may then skips (5030) the DL data from the SAT2 522 and will not initiate the Service Request procedure for data reception.

In some example embodiments, the UE 510 may transmit (5035) an indication to the SAT2 522 that the DL data #A is already received. In some example embodiments, the DL data #A may comprise multiple data packets and the indication may comprise the last ID (e.g. sequence number) for the received data packets. If the UE 510 supports EDT, the paging response to indicate that no need for downlink transmission in the step 5035 may be transmitted via preconfigured uplink resources, or as mobile-terminated early data transmission (MT-EDT) without establishing a RRC connection.

When the SAT1 521 is reconnected with the CN device 530, the SAT1 521 informs (5040) the CN device 530 that the DL data #A has been successfully delivered to the UE 510. For Control Plane CIoT EPS/5GS optimization, the step 5040 may be supported by the NAS DELIVERY INDICATION procedure. For User Plane CIoT EPS/5GS optimization, the step 5040 may require an enhancement, e.g. S1/NG-U to inform the SGW/UPF that a specific DL data has been successfully delivered to the UE.

Next, when the SAT2 522 is reconnected with the CN device 530, the CN device 530 informs (5045) the SAT2 522 to discard the buffered DL data #A.

In this way, the SAT2 522 is enabled to discard the buffered data even if the SAT2 522 did not transmit the DL data to the UE and even if the “discard” condition is absent, such that the SAT2 522 does not need to carry the DL data until a next revisit of the cell area.

FIG. 6 illustrates another example implementation of a process 600 for communication according to embodiments of the present disclosure. It is noted that the process 600 can be deemed as a more specific example of the process 400 of FIG. 4 applied into an NTN network. The example implementation of FIG. 6 is depicted and will be described from perspectives of a UE 610, a SAT1 621, a SAT2 622, and a CN device 630. More particularly, the SAT1 621 and the SAT2 622 moves relative to the CN device 630. Each of the SAT1 621 and the SAT2 622 may communicate with the CN device 630 when connected to the CN device 630. The connection between the CN device 630 and each of the SAT1 621 and the SAT2 622 is temporary and discontinuous. Each of the SAT1 621 and the SAT2 622 may communicate with the UE 610 when connected to the UE 610. The connection between the UE 610 and each of the SAT1 621 and the SAT2 622 is temporary and discontinuous. The CN device 630 communicates with the UE 610 via the SAT1 621 and the SAT2 622.

In the process flow 600, the CN device 630 may receive (6005) DL data #B to be transmitted to the UE 610 at a time point T2. The CN device 630 may decide to deliver the DL data #B via the SAT1 621 and the SAT2 622.

Next, when the SAT2 622 connects with the CN device 630, the CN device 630 transmits (6010), to the SAT2 622, information including DL data #B, the ID of the DL data #B (e.g., T2) and the ID of the satellites (i.e., SAT1 and SAT2) that will send the DL data #B.

After the transmission step 6010, the CN device 630 may receive (6015) DL data #C to be transmitted to the UE 610 at a time point T3.

Next, when the SAT1 621 connects with the CN device 630, the CN device 630 transmits (6020), to the SAT1 621, information including DL data #B, DL data #C, the IDs of the DL data #B and the DL data #C (e.g., T2 and T3) and the IDs of the satellites (i.e., SAT1 and SAT2). When the DL data #B or the DL data #C comprises multiple DL data packets, the information transmitted from the CN device 630 to the SAT may comprises the ID for each data packet.

Next, when the SAT2 622 serves the area where the UE 610 locates at, the SAT2 622 transmits (6025), the DL data #B to the UE 610. The ID of the DL data #B and the ID of the satellites (i.e., SAT1 and SAT2) that will send the DL data #B are also transmitted to the UE 610.

Next, when the SAT1 621 arrives at the area where the UE 610 locates at, the SAT1 621 transmits (6030) a paging message to the UE 610 to initiate a paging procedure. The paging message includes the IDs of the DL data #B and the DL data #C (e.g., T2 and T3) in addition to the legacy indication of UE identity. Optionally, the paging message further includes SAT information (e. g. SAT1 and SAT2).

Upon receiving the paging message from the SAT1 621, the UE 610 knows that there is new DL data from SAT1. The UE 610 transmits (6035) a RRC message to respond to the paging message, and initiates a RRC procedure. The RRC message indicates that the UE 610 has already received the DL data #B. The RRC message conveying this indication may be msg3 or any other RRC messages. In some example embodiments, the indication may comprise the ID of the last received data packet, i.e., data #B. The SAT1 621 thus knows that the DL data #B has already been received by the UE 621.

Upon receiving the message indicating that the DL data #B is already received, the SAT1 621 only transmits (6040) the DL data #C to the UE 610.

According to embodiments of the present disclosure, a new Adaptation layer is thus introduced, and is terminated at the UE and at the CN device (e.g. a SGW in EPC, or a UPF in 5GC). For each DL data packet, the CN device adds an ID and provides this ID to the access network device (for example, a satellite), which then forwards the ID to the UE. Based on this ID, the UE determines whether continue the normal service request procedure upon the reception of a paging message.

In this way, the core network may utilize multiple access network devices to attempt to transmit data to the terminal device, thereby improving the success rate of transmission and reducing transmission latency, for example, enabling the DL data to be transmitted to the terminal device as early as possible. By including identification information of the DL data in the paging message, the terminal device can determine whether it has received the DL data or part of the DL data, thus avoiding duplicated reception of the same data from multiple access network devices to the same terminal device. So it can reduce energy consumption and resource overhead. Additionally, these access network devices are enabled to discard DL data cached in them according to certain rules, such that they won't carry these DL data all the time and persistently attempt to transmit the DL data to the terminal device in subsequent pass-overs.

It is to be understood that the above embodiments described in connection with FIGS. 3 to 6 may be carried out separately or in any suitable combination.

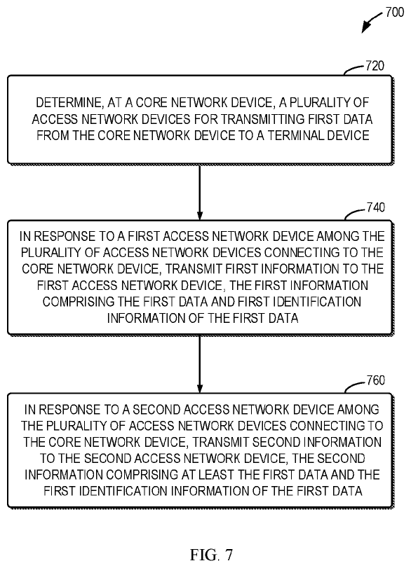

Accordingly, embodiments of the present disclosure provide methods of communication implemented at a terminal device and an access network device. These methods will be described below with reference to FIGS. 7 to 9.

FIG. 7 illustrates an example method 700 of communication implemented at a core network device in accordance with some example embodiments of the present disclosure. For example, the method 700 may be performed at the core network device 130 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 720, the core network device 130 determines a plurality of access network devices (for example, the first access network device 121 and the second access network device 122) for transmitting first data from the core network device to a terminal device. Each of the plurality of access network devices moves relative to the core network device 130.

At block 740, in response to a first access network device among the plurality of access network devices connecting to the core network device, the core network device 130 transmits first information to the first access network device, the first information comprising the first data and first identification information of the first data.

At block 760, in response to a second access network device among the plurality of access network devices connecting to the core network device, the core network device 130 transmits second information to the second access network device, the second information comprising at least the first data and the first identification information of the first data.

In some example embodiments, the core network device 130 determines the plurality of access network devices by determining that a coverage area of each of the plurality of access network devices at least partially overlaps at least one of a tracking area, a registration area, and a potential area associated with the terminal device, during a period of time.

In some example embodiments, the first identification information comprises identifiers associated with respective data packets of the first data.

In some example embodiments, each of the identifiers comprises at least one of: a timestamp when the core network device received the associated data packet; and a sequence number of the associated data packet.

In some example embodiments, the first identification information comprises at least one of: the number of data packets of the first data; an identifier associated with a first data packet of the first data; and an identifier associated with a last data packet of the first data.

In some example embodiments, in response to determining, after transmitting the first information, that second data is to be transmitted from the core network device to the terminal device, the core network device 130 generates the second information to further comprise the second data and second identification information of the second data.

In some example embodiments, the first information further comprises a condition for the first access network device to discard the first data.

In some example embodiments, the condition comprises at least one of: an area being arrived by the first access network device, an area being passed by the first access network device, a time point being reached, and a period of time having elapsed since the first access network device receives the first information.

In some example embodiments, the core network device 130 receives, from the first access network device reconnecting to the core network device 130, an indication that the first data is transmitted to the terminal device successfully. In response to the second access network device reconnecting to the core network device 130, the core network device 130 transmits, to the second access network device, an indication of discarding the first data.

In some example embodiments, each of the first and second information further comprises information of the plurality of access network devices.

In some example embodiments, an apparatus capable of performing the method 700 (for example, the core network device 130) may comprise means for performing the respective steps of the method 700. The means may be implemented in any suitable form. For example, the means may be implemented in a circuitry or software module.

In some example embodiments, the apparatus comprises: means for determining a plurality of access network devices for transmitting first data from the core network device to a terminal device, each of the plurality of access network devices moving relative to the core network device; means for transmitting first information to the first access network device in response to a first access network device among the plurality of access network devices connecting to the core network device, the first information comprising the first data and first identification information of the first data; and means for transmitting second information to the second access network device in response to a second access network device among the plurality of access network devices connecting to the core network device, the second information comprising at least the first data and the first identification information of the first data.

In some example embodiments, the means for determining the plurality of access network devices comprises: means for determining that a coverage area of each of the plurality of access network devices at least partially overlaps at least one of a tracking area, a registration area, and a potential area associated with the terminal device, during a period of time.

In some example embodiments, the first identification information comprises identifiers associated with respective data packets of the first data.

In some example embodiments, each of the identifiers comprises at least one of: a timestamp when the core network device received the associated data packet; and a sequence number of the associated data packet.

In some example embodiments, the first identification information comprises at least one of: the number of data packets of the first data; an identifier associated with a first data packet of the first data; and an identifier associated with a last data packet of the first data.

In some example embodiments, the apparatus further comprises: means for generating the second information to further comprise the second data and second identification information of the second data in response to determining, after transmitting the first information, that second data is to be transmitted from the core network device to the terminal device.

In some example embodiments, the first information further comprises a condition for the first access network device to discard the first data.

In some example embodiments, the condition comprises at least one of: an area being arrived by the first access network device, an area being passed by the first access network device, a time point being reached, and a period of time having elapsed since the first access network device receives the first information.

In some example embodiments, the apparatus further comprises: means for receiving, from the first access network device reconnecting to the core network device, an indication that the first data is transmitted to the terminal device successfully; and means for transmitting, to the second access network device, an indication of discarding the first data in response to the second access network device reconnecting to the core network device.

In some example embodiments, each of the first and second information further comprises information of the plurality of access network devices.

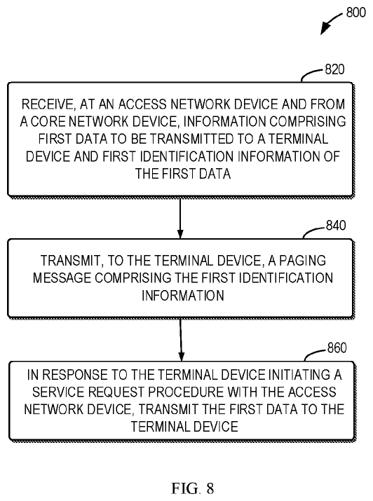

FIG. 8 illustrates an example method 800 of communication implemented at an access network device in accordance with some example embodiments of the present disclosure. For example, the method 800 may be performed at the access network device 121 or 122 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 820, an access network device (for example, the first access network device 121 or the second access network device 122) receives, from a core network device 130, information comprising first data to be transmitted to a terminal device and first identification information of the first data, wherein the access network device moves relative to the core network device 130.

At block 840, the access network device transmits, to the terminal device, a paging message comprising the first identification information.

At block 860, in response to the terminal device initiating a service request procedure with the access network device, the access network device transmits the first data to the terminal device.

In some example embodiments, the access network device is further caused to: in response to receiving, from the terminal device, an indication that the first data is previously received by the terminal device, discard the first data.

In some example embodiments, the indication comprises an identifier associated with a last data packet of the first data.

In some example embodiments, the information further comprises second data to be transmitted to the terminal device and second identification information of the second data, and the paging message further comprises the second identification information.

In some example embodiments, in response to receiving, from the terminal device, an indication that the second data is previously received by the terminal device, the access network device transmits the first data to the terminal device without transmitting the second data to the terminal device.

In some example embodiments, in response to reconnecting to the core network device, the access network device transmits, to the core network device, an indication that the first data is transmitted to the terminal device successfully.

In some example embodiments, the access network device discards the first data in response to: a condition for discarding the first data being met; or receiving, from the core network device, an indication of discarding the first data.

In some example embodiments, the condition comprises at least one of: an area being arrived by the first access network device, an area being passed by the access network device, a time point being reached, and a period of time having elapsed since the access network device receives the information.

In some example embodiments, the condition is comprised in the information.

In some example embodiments, the first identification information comprises identifiers associated with respective data packets of the first data.

In some example embodiments, each of the identifiers comprises at least one of: a timestamp when the core network device received the associated data packet; and a sequence number of the associated data packet.

In some example embodiments, the first identification information comprises at least one of: the number of data packets of the first data; an identifier associated with a first data packet of the first data; and an identifier associated with a last data packet of the first data.

In some example embodiments, the paging message further comprises information of a plurality of access network devices for transmitting the first data from the core network device to the terminal device.

In some example embodiments, an apparatus capable of performing the method 800 (for example, the first access network 121 or the second access network 122) may comprise means for performing the respective steps of the method 800. The means may be implemented in any suitable form. For example, the means may be implemented in a circuitry or software module.

In some example embodiments, the apparatus comprises: means for receiving, from a core network device, information comprising first data to be transmitted to a terminal device and first identification information of the first data, wherein the access network device moves relative to the core network device; means for transmitting, to the terminal device, a paging message comprising the first identification information; and means for transmitting the first data to the terminal device in response to the terminal device initiating a service request procedure with the access network device.

In some example embodiments, the apparatus further comprises: means for discarding the first data in response to receiving, from the terminal device, an indication that the first data is previously received by the terminal device.

In some example embodiments, the indication comprises an identifier associated with a last data packet of the first data.

In some example embodiments, the information further comprises second data to be transmitted to the terminal device and second identification information of the second data, and the paging message further comprises the second identification information.

In some example embodiments, the means for transmitting the first data comprises: means for transmitting the first data to the terminal device without transmitting the second data to the terminal device in response to receiving, from the terminal device, an indication that the second data is previously received by the terminal device.

In some example embodiments, the apparatus further comprises: means for transmitting, to the core network device, an indication that the first data is transmitted to the terminal device successfully in response to reconnecting to the core network device.

In some example embodiments, the apparatus further comprises: means for discarding the first data in response to a condition for discarding the first data being met or receiving, from the core network device, an indication of discarding the first data.

In some example embodiments, the condition comprises at least one of: an area being arrived by the first access network device, an area being passed by the access network device, a time point being reached, and a period of time having elapsed since the access network device receives the information.

In some example embodiments, the condition is comprised in the information.

In some example embodiments, the first identification information comprises identifiers associated with respective data packets of the first data.

In some example embodiments, each of the identifiers comprises at least one of: a timestamp when the core network device received the associated data packet; and a sequence number of the associated data packet.

In some example embodiments, the first identification information comprises at least one of: the number of data packets of the first data; an identifier associated with a first data packet of the first data; and an identifier associated with a last data packet of the first data.

In some example embodiments, the paging message further comprises information of a plurality of access network devices for transmitting the first data from the core network device to the terminal device.

FIG. 9 illustrates an example method 900 of communication implemented at a terminal device in accordance with some example embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 920, the terminal device 110 receives, from an access network device, a paging message comprising first identification information of first data. The access network device moves relative to the terminal device.

At block 940, the terminal device 110 determines, based on the first identification information, whether the first data is previously received by the terminal device.

At block 960, in response to determining that the first data is not previously received, the terminal device 110 initiates a service request procedure with the access network device.

At block 980, the terminal device 110 receives the first data from the access network device.

In some example embodiments, in response to determining that the first data is previously received, the terminal device 110 transmits, to the access network device, an indication that the first data is previously received by the terminal device.

In some example embodiments, in response to determining that the first data is previously received, the terminal device 110 skips the initiation of the service request procedure.

In some example embodiments, the paging message further comprises second identification information of second data.

In some example embodiments, in response to determining, based on the second identification information, that the second data is previously received by the terminal device, the terminal device 110 transmits a message to the access network device during the service request procedure. The message indicates that the second data is previously received by the terminal device.

In some example embodiments, the first identification information comprises identifiers associated with respective data packets of the first data.

In some example embodiments, each of the identifiers comprises at least one of: a timestamp when a core network device received the associated data packet; and a sequence number of the associated data packet.

In some example embodiments, the identification information comprises at least one of: the number of data packets of the first data; an identifier associated with a first data packet of the first data; and an identifier associated with a last data packet of the first data.

In some example embodiments, the paging message further comprises information of a plurality of access network devices for transmitting the first data from a core network device to the terminal device.

In some example embodiments, the terminal device 110 determines, based on the information of the plurality of access network devices, an arrival time when a beam coverage area of a second access network device among the plurality of access network devices at least partially overlaps at least one of a tracking area, a registration area, and a potential area associated with the terminal device. The terminal device 110 detects a second paging message from the second access network device at the arrival time.

In some example embodiments, the terminal device 110 determines, based on the information of the plurality of access network devices, that a second access network device is among the plurality of access network devices and is to transmit the first data to the terminal device. In response to receiving a second paging message from the second access network device, the terminal device 110 determines whether the second paging message comprises second identification information of second data in addition to the first identification information.

In some example embodiments, in response to determining that the second paging message comprises the second identification information, the terminal device 110 initiates a second service request procedure with the second access network device. The terminal device 110 then receives the second data from the access network device.

In some example embodiments, the terminal device 110 transmits a second message to the second access network device during the second service request procedure. The second message indicates that the first data is previously received by the terminal device.

In some example embodiments, in response to determining that the second paging message does not comprise other identification information different from the first identification information, the terminal device 110 transmits, to the second access network device, an indication that the first data is previously received by the terminal device, or skips an initiation of a service request procedure with the second access network device.

In some example embodiments, the terminal device 110 determines, based on a predefined purpose of the first data, that a core network device associated with the first data is not to transmit second data to the terminal device before the terminal device transmits response data for the first data to the core network device, or before a timer is expired (for example, no second data in a 24-hour period). The terminal device 110 determines, based on the information of the plurality of access network devices, that a second access network device is among the plurality of access network devices and is to transmit the first data to the terminal device. In response to receiving a second paging message from the second access network device, the terminal device 110 skips an initiation of a second service request procedure with the second access network device.

In some example embodiments, an apparatus capable of performing the method 900 (for example, the terminal device 110) may comprise means for performing the respective steps of the method 900. The means may be implemented in any suitable form. For example, the means may be implemented in a circuitry or software module.

In some example embodiments, the apparatus comprises: means for receiving, from an access network device, a paging message comprising first identification information of first data, wherein the access network device moves relative to the terminal device; means for determining, based on the first identification information, whether the first data is previously received by the terminal device; means for initiating a service request procedure with the access network device in response to determining that the first data is not previously received; and means for receiving the first data from the access network device.

In some example embodiments, the apparatus further comprises: means for transmitting, to the access network device, an indication that the first data is previously received by the terminal device in response to determining that the first data is previously received.

In some example embodiments, the apparatus further comprises: means for skipping the initiation of the service request procedure in response to determining that the first data is previously received.

In some example embodiments, the paging message further comprises second identification information of second data.

In some example embodiments, the apparatus further comprises: means for transmitting a message to the access network device during the service request procedure in response to determining, based on the second identification information, that the second data is previously received by the terminal device, the message indicating that the second data is previously received by the terminal device.

In some example embodiments, the first identification information comprises identifiers associated with respective data packets of the first data.

In some example embodiments, each of the identifiers comprises at least one of: a timestamp when a core network device received the associated data packet; and a sequence number of the associated data packet.

In some example embodiments, the identification information comprises at least one of: the number of data packets of the first data; an identifier associated with a first data packet of the first data; and an identifier associated with a last data packet of the first data.

In some example embodiments, the paging message further comprises information of a plurality of access network devices for transmitting the first data from a core network device to the terminal device.

In some example embodiments, the apparatus further comprises: means for determining, based on the information of the plurality of access network devices, an arrival time when a beam coverage area of a second access network device among the plurality of access network devices at least partially overlaps at least one of a tracking area, a registration area, and a potential area associated with the terminal device; and means for detecting a second paging message from the second access network device at the arrival time.

In some example embodiments, the apparatus further comprises: means for determining, based on the information of the plurality of access network devices, that a second access network device is among the plurality of access network devices and is to transmit the first data to the terminal device; and means for determining whether the second paging message comprises second identification information of second data in addition to the first identification information in response to receiving a second paging message from the second access network device.

In some example embodiments, the apparatus further comprises: means for initiating a second service request procedure with the second access network device in response to determining that the second paging message comprises the second identification information; and means for receiving the second data from the access network device.

In some example embodiments, the apparatus further comprises: means for transmitting a second message to the second access network device during the second service request procedure, the second message indicating that the first data is previously received by the terminal device.

In some example embodiments, the apparatus further comprises: means for transmitting, to the second access network device, an indication that the first data is previously received by the terminal device in response to determining that the second paging message does not comprise other identification information different from the first identification information, or means for skipping an initiation of a service request procedure with the second access network device in response to determining that the second paging message does not comprise other identification information different from the first identification information.

In some example embodiments, the apparatus further comprises: means for determining, based on a predefined purpose of the first data, that a core network device associated with the first data is not to transmit second data to the terminal device before the terminal device transmits response data for the first data to the core network device, or before a timer is expired (for example, no second data in a 24-hour period); means for determining, based on the information of the plurality of access network devices, that a second access network device is among the plurality of access network devices and is to transmit the first data to the terminal device; and means for skipping an initiation of a second service request procedure with the second access network device in response to receiving a second paging message from the second access network device.

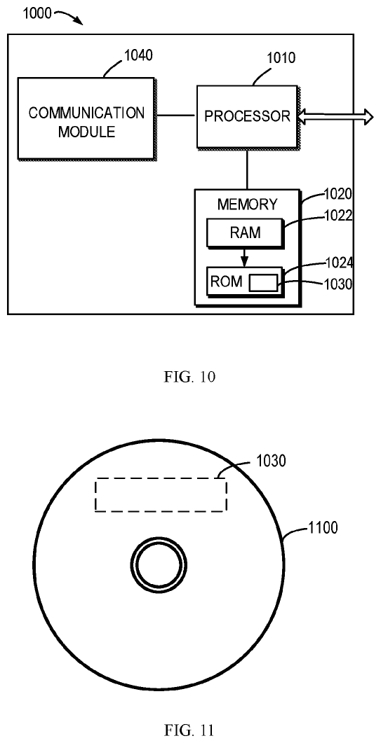

FIG. 10 illustrates a simplified block diagram of a device 1000 that is suitable for implementing some example embodiments of the present disclosure. The device 1000 may be provided to implement the communication device, for example the terminal device 110, the first access network device 121, the seconds access network device 122 and the CN device 130 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 3 to 6. The embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like.

FIG. 11 illustrates a block diagram of an example of a computer readable medium 1100 in accordance with some example embodiments of the present disclosure. The computer readable medium 1100 has the program 1030 stored thereon. It is noted that although the computer readable medium 1100 is depicted in form of CD or DVD in FIG. 11, the computer readable medium 1100 may be in any other form suitable for carry or hold the program 1030.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700, 800 or 900 as described above with reference to FIGS. 7 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A core network device comprising:
at least one processor; and
at least one memory comprising computer program code;
wherein the at least one memory and the computer program code are configured to, with the at least one processor, cause the core network device to:
determine a plurality of access network devices for transmitting first data from the core network device to a terminal device, each of the plurality of access network devices moving relative to the core network device;
in response to a first access network device among the plurality of access network devices connecting to the core network device, transmit first information to the first access network device, the first information comprising the first data and first identification information of the first data; and
in response to a second access network device among the plurality of access network devices connecting to the core network device, transmit second information to the second access network device, the second information comprising at least the first data and the first identification information of the first data.

2. The core network device of claim 1, wherein the core network device is caused to determine the plurality of access network devices by:
determining that a coverage area of each of the plurality of access network devices at least partially overlaps at least one of a tracking area, a registration area, and a potential area associated with the terminal device, during a period of time.

3-10. (canceled)

11. An access network device comprising:
at least one processor; and
at least one memory comprising computer program code;
wherein the at least one memory and the computer program code are configured to, with the at least one processor, cause the access network device to:
receive, from a core network device, information comprising first data to be transmitted to a terminal device and first identification information of the first data, wherein the access network device moves relative to the core network device;
transmit, to the terminal device, a paging message comprising the first identification information; and
in response to the terminal device initiating a service request procedure with the access network device, transmit the first data to the terminal device.

12. The access network device of claim 11, wherein the access network device is further caused to:
in response to receiving, from the terminal device, an indication that the first data is previously received by the terminal device, discard the first data.

13-23. (canceled)

24. A terminal device comprising:
at least one processor; and
at least one memory comprising computer program code;
wherein the at least one memory and the computer program code are configured to, with the at least one processor, cause the terminal device to:
receive, from an access network device, a paging message comprising first identification information of first data, wherein the access network device moves relative to the terminal device;
determine, based on the first identification information, whether the first data is previously received by the terminal device; and
in response to determining that the first data is not previously received,
initiate a service request procedure with the access network device; and
receive the first data from the access network device.

25. The terminal device of claim 24, wherein the terminal device is further caused to:
in response to determining that the first data is previously received, transmit, to the access network device, an indication that the first data is previously received by the terminal device.

26. The terminal device of claim 24, wherein the terminal device is further caused to:
in response to determining that the first data is previously received, skip the initiation of the service request procedure.

27. The terminal device of claim 24, wherein the paging message further comprises second identification information of second data.

28. The terminal device of claim 27, wherein the terminal device is further caused to:
in response to determining, based on the second identification information, that the second data is previously received by the terminal device, transmit a message to the access network device during the service request procedure, the message indicating that the second data is previously received by the terminal device.

29. The terminal device of claim 24, wherein the first identification information comprises identifiers associated with respective data packets of the first data.

30. The terminal device of claim 29, wherein each of the identifiers comprises at least one of:
a timestamp when a core network device received the associated data packet; and
a sequence number of the associated data packet.

31. The terminal device of claim 24, wherein the identification information comprises at least one of:
the number of data packets of the first data;
an identifier associated with a first data packet of the first data; and
an identifier associated with a last data packet of the first data.

32. The terminal device of claim 24, wherein the paging message further comprises information of a plurality of access network devices for transmitting the first data from a core network device to the terminal device.

33. The terminal device of claim 32, wherein the terminal device is further caused to:
determine, based on the information of the plurality of access network devices, an arrival time when a beam coverage area of a second access network device among the plurality of access network devices at least partially overlaps at least one of a tracking area, a registration area, and a potential area associated with the terminal device; and
detect a second paging message from the second access network device at the arrival time.

34. The terminal device of claim 24, wherein the paging message further comprises information of a plurality of access network devices for transmitting the first data from a core network device to the terminal device; and wherein the terminal device is further caused to:
determine, based on the information of the plurality of access network devices, that a second access network device is among the plurality of access network devices and is to transmit the first data to the terminal device; and
in response to receiving a second paging message from the second access network device, determine whether the second paging message comprises second identification information of second data in addition to the first identification information.

35. The terminal device of claim 34, wherein the terminal device is further caused to:
in response to determining that the second paging message comprises the second identification information,
initiate a second service request procedure with the second access network device; and
receive the second data from the access network device.

36. The terminal device of claim 34, wherein the terminal device is further caused to:
in response to determining that the second paging message comprises the second identification information,
initiate a second service request procedure with the second access network device;
receive the second data from the access network device; and
transmit a second message to the second access network device during the second service request procedure, the second message indicating that the first data is previously received by the terminal device.

37. The terminal device of claim 34, wherein the terminal device is further caused to:
in response to determining that the second paging message does not comprise other identification information different from the first identification information,
transmit, to the second access network device, an indication that the first data is previously received by the terminal device, or
skip an initiation of a service request procedure with the second access network device.

38. The terminal device of claim 32, wherein the terminal device is further caused to:
determine, based on a predefined purpose of the first data, that a core network device associated with the first data is not to transmit second data to the terminal device before the terminal device transmits response data for the first data to the core network device;
determine, based on the information of the plurality of access network devices, that a second access network device is among the plurality of access network devices and is to transmit the first data to the terminal device; and
in response to receiving a second paging message from the second access network device, skip an initiation of a second service request procedure with the second access network device.

39-45. (canceled)
